(19) United States
(12) Patent Application Publication
(10) Pub. No.: US 2019/0006645 A1
(43) Pub. Date: Jan. 3, 2019

(54) BATTERY MODULE

(71) Applicant: LG ELECTRONICS INC., Seoul (KR)

(72) Inventor: Kwangmo KIM, Seoul (KR)

(21) Appl. No.: 16/018,743

(22) Filed: Jun. 26, 2018

(30) Foreign Application Priority Data
Jun. 30, 2017 (KR) 10-2017-0083631

(51) Int. Cl. H01M 2/10; H01M 2/30; H01M 2/20; B60L 11/18; B60K 1/04

(52) U.S. Cl. CPC H01M 2/1077; H01M 2/305; H01M 2/206; B60K 2001/0438; B60K 1/04; H01M 2220/20; B60L 11/1879

(57) ABSTRACT

A battery module comprising a first cell having a first electrode terminal, a second cell having a second electrode terminal, and the first electrode terminal and the second electrode terminal forming an electrode terminal set; at least one bus bar having a bus bar contact surface, a support provided on one side of the first and second cells, and at least one cover clip that engages into the support to sandwich the electrode terminal set and the bus bar contact surface to prevent separation of contact between at least one of (a) the first and second electrode terminals or (b) the bus bar contact surface and the electrode terminal set.

### CROSS-REFERENCE TO RELATED APPLICATION

This application claims the priority benefit of Korean Patent Application No. 10-2017-0083631, filed in Korea on Jun. 30, 2017 in the Korean Intellectual Property Office, the disclosure of which is incorporated herein by reference in its entirety.

### BACKGROUND

### 1. Field

The present disclosure relates to a battery module, and more particularly to a battery module in which battery cells are detachably coupled to the battery module.

### 2. Background

Vehicles that are designed to generate driving force from engines using fossil fuels are problematic in that they cause air pollution. In order to overcome this problem, there is proposed a technology in which a secondary battery capable of being charged and discharged is used as the power source of a vehicle. In recent years, an electric vehicle (EV) capable of being operated using only a battery, a hybrid electric vehicle (HEV) capable of being operated using a combination of a battery and an existing engine have been developed and commercialized. As a secondary battery serving as a power source of an electric vehicle, a hybrid electric vehicle and the like, a nickel-metal-hydride battery, a lithium-ion battery or the like is used.

Since a high-output and high-capacity battery is required in order to be used as a power source of an electric vehicle, a hybrid electric vehicle or the like, a medium and large-sized battery module in which a large number of small-sized secondary batteries (unit batteries) are connected to each other in series and/or in parallel has been used. Laser welding, ultrasonic welding or the like is used in a process of connecting small-sized secondary batteries (unit batteries) in series and/or in parallel.

However, in the case of a battery module composed of a large number of small-sized secondary batteries which are connected to each other by using, for example, welding, when a problem occurs in one among the large number of small-sized secondary batteries constituting the battery module, the entire battery module may require replacement with a new battery module because it is not possible to remove only the problematic small-sized secondary battery.

### BRIEF DESCRIPTION OF THE DRAWINGS

Embodiments will be described in detail with reference to the following drawings in which like reference numerals refer to like elements, and wherein:

FIG. 1 is a schematic view of a vehicle 1 including a battery module 100 according to an embodiment of the present disclosure;

FIG. 2 is an exploded perspective view of a battery pack 10 including the battery module 100 according to the embodiment of the present disclosure;

FIG. 3 is a perspective view of the battery module 100 according to the embodiment of the present disclosure;

FIG. 4 is an enlarged view of portion A of FIG. 3, in which a circuit board 140 and a cover clips 160 are removed from the battery module 100;

FIG. 5 is an enlarged view of portion A of FIG. 3, in which some of the cover clips 160 are removed from the battery module 100;

FIG. 6 is an enlarged view of portion B of FIG. 5;

FIG. 7 is an enlarged view corresponding to FIG. 6, in which the cover clips 160 are coupled to the circuit board 140;

FIG. 8 is a perspective view of the cover clip 160 of the embodiment of the present disclosure;

FIG. 9 is a cross-sectional view taken along line C-C′ of FIG. 7;

FIG. 10 is a cross-sectional view taken along line D-D′ of FIG. 7;

FIG. 11 is a fragmentary perspective view of a battery module 200 according to a second embodiment of the present disclosure;

FIG. 12 is a perspective view of a cover clip 360 according to a third embodiment of the present disclosure;

FIG. 13 is a perspective view of a cover clip 460 according to a fourth embodiment of the present disclosure;

FIG. 14 is a perspective view of a bus bar 450 according to the fourth embodiment of the present disclosure;

FIG. 15 is a perspective view of a circuit board 440, the bus bar 450 and the cover clip 460, according to the fourth embodiment of the present disclosure;

FIG. 16 is a fragmentary cross-sectional view of a battery module 400 according to the fourth embodiment of the present disclosure, which is taken along line D-D′ of FIG. 7;

FIG. 17 is a perspective view of a cover clip 560 according to a fifth embodiment of the present disclosure;

FIG. 18 is a fragmentary cross-sectional view of a battery module 500 according to the fifth embodiment of the present disclosure, which is taken along line D-D′ of FIG. 7; and

FIG. 19 is a perspective view of a cover clip 660 according to a sixth embodiment of the present disclosure.

### DETAILED DESCRIPTION

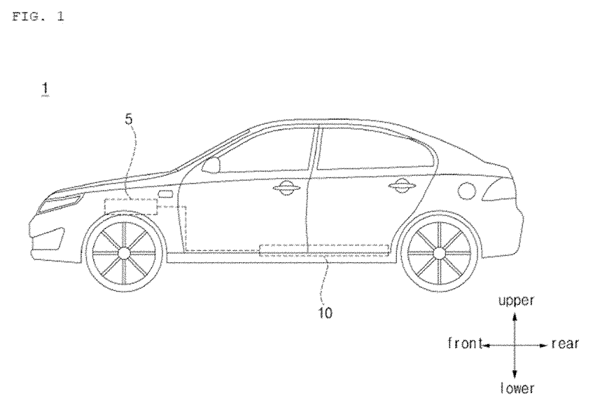

Referring to FIG. 1, a vehicle 1 according to an embodiment of the present may include a motor 5 for generating power required to drive the vehicle 1. The motor 5 is operated by electrical energy supplied from a battery pack 10, and is able to convert the electrical energy into kinetic energy.

The vehicle 1 may include the battery pack 10 for generating electrical energy. The battery pack 10 may be positioned at the center of the bottom of the vehicle body. However, other locations may be possible.

The battery pack 10 may be disposed between a front rotating shaft and a rear rotating shaft of the vehicle 1. The bottom of the vehicle body may be disposed at the lower side of the vehicle interior. The vehicle interior may be provided with an instrument panel, a center console box and a sheet. The battery pack 10 may be disposed outside the vehicle interior, and the battery pack 10 may be disposed at a lower portion of the bottom of the vehicle body. The battery pack 10 may serve to replace a fuel tank of an internal-combustion vehicle. The battery pack 10 may be charged to increase energy stored or discharged to decrease energy stored in the battery pack 10. The battery pack 10 may generate heat during charging and discharging.

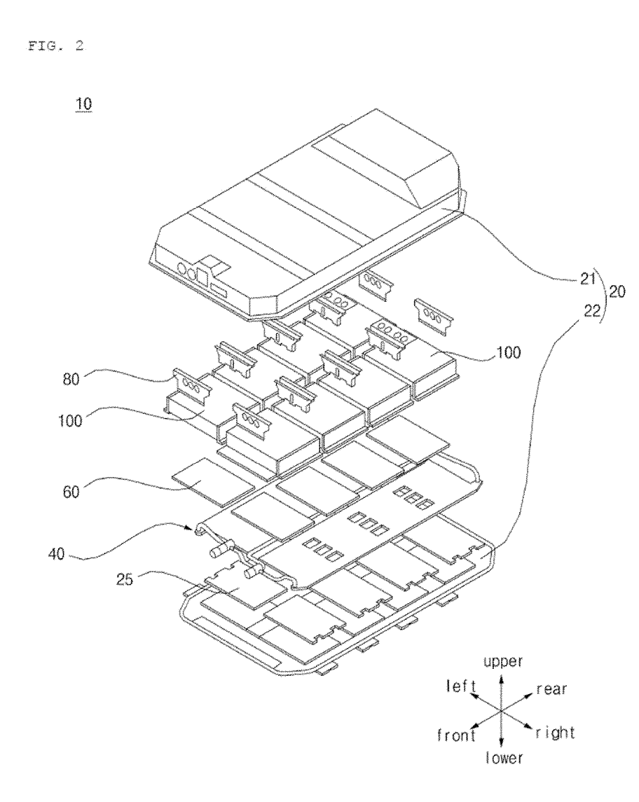

Referring to FIG. 2, the battery pack 10 may include a casing 20 defining the appearance of the battery pack 10. The casing 20 may include a cover 21 coupled to a tray 22 so as to cover the battery module 100. The casing 20 may include the tray 22 for supporting the load of the battery module 100. The casing 20 may include support panels 25, which are intended to increase rigidity of the tray 22 and to uniformly distribute the load of a heat sink 40 to the tray 22.

The battery pack 10 may include the heat sink 40 in which cooling water, cooling water with additive or other coolant, absorbing heat energy generated from the battery module 100, flows. The heat sink 40 is made of a material having a high coefficient of heat transfer, and allows cooling water or other coolant to flow therein.

The battery pack 10 may include thermal pads 60 for transferring heat energy from the battery module 100 to the heat sink 40. The thermal pads 60 may be thermal conductive pads. The thermal pads 60 may be made of a material having high heat conductivity. The battery pack 10 may also include brackets 80.

The battery pack 10 may include the battery module 100 having battery cells for generating electrical energy. The battery module 100 may include a plurality of battery modules contained in the battery pack 10. The battery pack 10 may be configured such that the plurality of battery modules 100 are electrically connected to each other. The battery pack 10 may be configured such that the plurality of battery modules 100 are disposed on the same plane. The battery pack 10 may be configured such that the plurality of battery modules 100 are arranged one above the other.

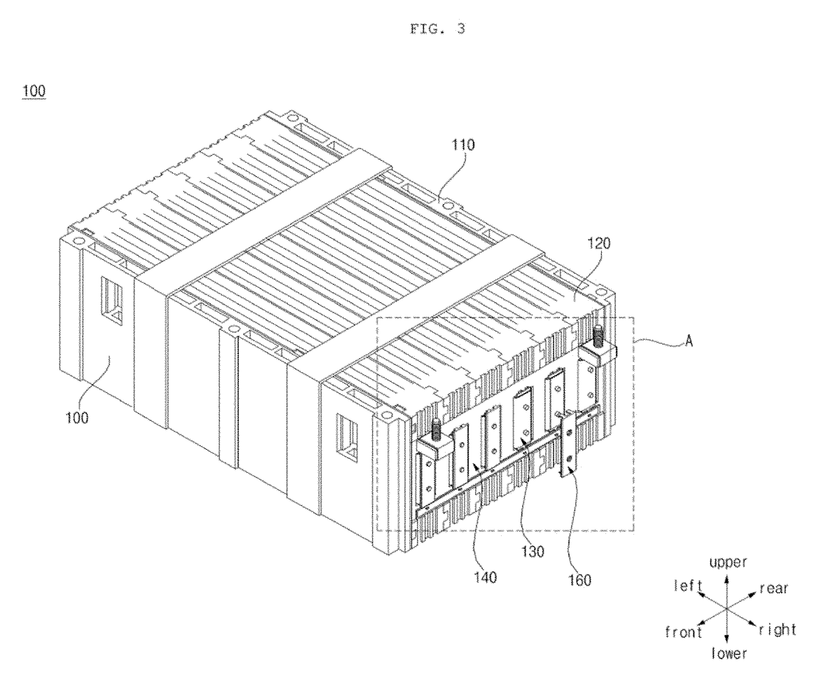

The battery module 100 according to an embodiment of the present disclosure will be described with reference to FIGS. 3 to 10. The battery module 100 may include a plurality of battery cells 130, which are stacked one on each other. Each of the battery cells 130 may include an electrode terminal 133 (including 133a, 133b for example), which is protruded and bent in one direction. The battery module 100 may include bus bars 150, each of which functions to electrically connect adjacent bent electrode terminals of the battery cells 130. The battery module 100 may include a circuit board 140, which is disposed at a first side of the plurality of battery cells 130 and which includes voltage terminals through which voltage is input and output. The battery module 100 may include cover clips 160, which are coupled to the circuit board 140 so as to bring the bent electrode terminals 133 into contact with the bus bars 150 so as to sandwich the bent electrode terminals, or electrode terminal set, and bus bar contact surfaces, of the bus bars, to prevent separation of or maintain contact between.

Referring to FIG. 3, the battery module 100 may be configured to have a rectangular parallelepiped shape overall. A plurality of battery modules 100 may be disposed in the battery pack 10. The plurality of battery modules 100 may be disposed in the same plane in the battery pack 10. The plurality of battery modules 100 may be disposed one over the other in the battery pack 10.

The battery module 100 may include a cartridge cover 110 for covering at least one side of the stacked body or stack in which a plurality of cell cartridges 120 are stacked. The cartridge cover 110 may cover opposite sides of the stacked body of the plurality of cell cartridges 120. Specifically, the cartridge cover 110 may cover opposite sides of the stacked body in the direction in which the plurality of cell cartridges 120 are stacked.

A pair of cartridge covers 110 may cover the opposite sides of the stacked body in the direction in which the plurality of cell cartridges 120 are stacked. The pair of cartridge covers 110 may cover opposite sides of the stacked body in the direction in which the plurality of cell cartridges 120 are stacked. The cartridge cover 110 may protect the cell cartridges 120 from external shocks. The cartridge cover 110 may also prevent foreign matter from entering the cell cartridges 120.

The cartridge cover 110 may be coupled to the cell cartridge 120. The cartridge cover 110 may be coupled to the cell cartridge 120 by using, for example, coupling elements. The cartridge cover 110 may be fastened to the cell cartridge 120 by using, for example, fastening elements or fasteners. The cartridge cover 110 may be configured to provide coupling force to the plurality of cell cartridges 120.

One of the cartridge cover 110 and the cell cartridge 120 may be provided with a protrusion while the other of the cartridge cover 110 and the cell cartridge 120 may be provided with a recess corresponding to the protrusion in order to increase the coupling force between the cartridge cover 110 and the cell cartridge 120.

The cell cartridge 120 may be configured to have a rectangular parallelepiped shape. The cell cartridge 120 may be made of a material having high thermal conductivity, which may efficiently transfer the heat generated from the battery cell 130 to the outside of the cell cartridge 120.

The cell cartridge 120 may have a space for accommodating the battery cell 130. The cell cartridge 120 may accommodate at least one battery cell 130 therein. In the embodiment, the cell cartridge 120 accommodates two battery cells 130 therein. However, the cell cartridge 120 may also accommodate three or more battery cells 130.

The cell cartridge 120 may be provided with a thermal interface material (TIM) for improving thermal conductivity, in which the thermal interface material is provided on the surface of the cell cartridge 120 that the battery cell 130 contacts. The cell cartridge 120 may be configured to be open on at least one side thereof. In the embodiment, the cell cartridge 120 is open at opposite sides thereof. However, the cell cartridge 120 may be configured to be open only on one side thereof.

The cell cartridge 120 may be composed of a plurality of cell cartridges 120, which are stacked one on each other. The plurality of cell cartridges 120 may be configured to have shapes engaging with each other such that the plurality of cell cartridges 120 are stacked one on each other in an engaging manner.

The cell cartridge 120 may be disposed to be able to contact the cartridge cover 110. The cell cartridge 120 may be covered on at least one side thereof with the cartridge cover 110. The cell cartridge 120 may be covered on opposite sides thereof with the cartridge cover 110. The cell cartridge 120 may be covered at opposite sides thereof with the cartridge cover 110 in the direction in which the plurality of cell cartridges 120 are stacked. The battery cell 130 may generate electrical energy by virtue of a chemical reaction. The battery cell 130 may be of a pouch cell.

At least one battery cell 130 may be accommodated in the cell cartridge 120. In the embodiment, two battery cells 130 are accommodated in the cell cartridge 120. However, three or more battery cells 130 may also be accommodated in the cell cartridge 120.

The battery cell 130 may be composed of a plurality of battery cells, which are stacked one on each other. The plurality of battery cells 130 may be electrically connected to each other.

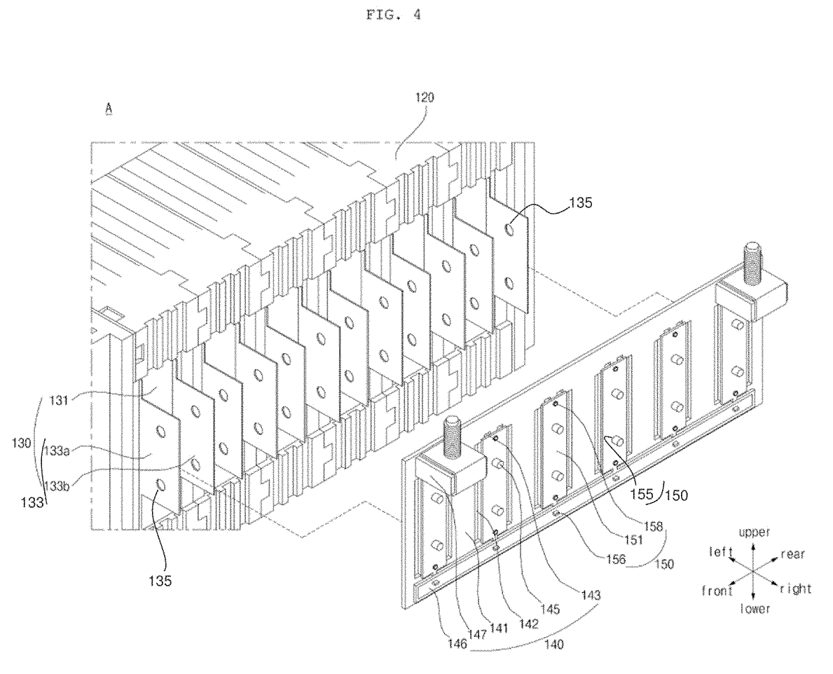

Referring to FIG. 4, the battery cell 130 may include a cell body 131, which generates electrical energy therein. The cell body 131 may be accommodated in the cell cartridge 120.

The cell body 131 may include an electrode terminal 133 for supplying electrical energy generated therein to the outside of the cell body 131. The cell body 131 may include the electrode terminal 133 protruding toward at least one side. The cell body 131 may include the electrode terminal 133 protruding to the left and/or right. In the embodiment, the cell body 131 may include electrode terminals 133 that respectively protrude to the left and right.

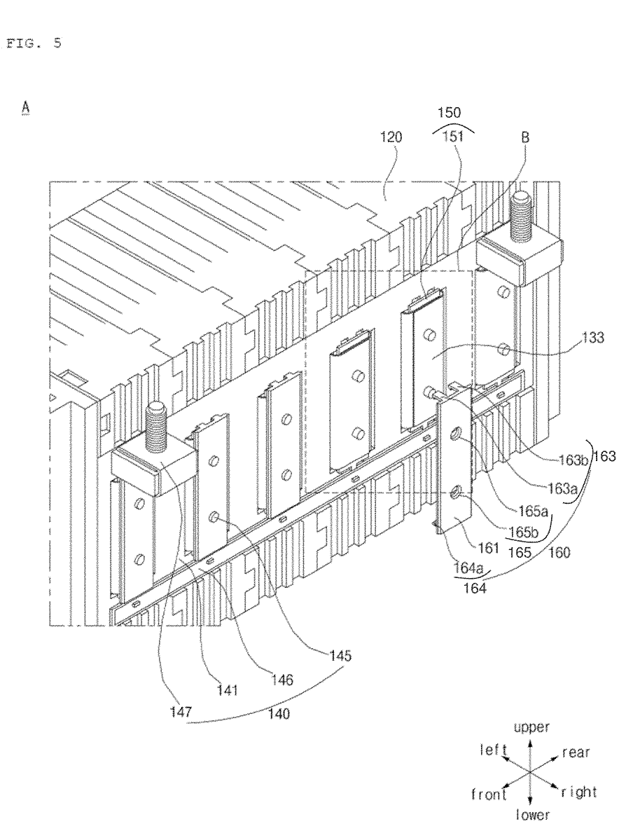

The electrode terminal 133 may electrically connect adjacent battery cells 130 to each other. Referring to FIG. 5, the electrode terminal 133 may be bent at least once. The electrode terminal 133 may transfer electrical energy in the battery cell 130 to the outside of the battery cell 130.

The electrode terminals 133 of different cell bodies 131 may be brought into contact with each other, and may thus be electrically connected to each other. The electrode terminals 133 of a plurality of adjacent cell bodies 131 are electrically connected to each other, and may be connected to each other in series in order to generate resultant power. The electrode terminals 133 of a plurality of adjacent cell bodies 131 are electrically connected to each other, and may be connected to each other in parallel so as to generate the resultant power.

Referring to FIG. 5, a plurality of bent electrode terminals 133 may penetrate the circuit board 140, and may be disposed between the circuit board 140 and the cover clips 160 in a stacked state. The length that the electrode terminal 133 protrudes may be set such that the electrode terminal 133 contacts the bus bar 150 at a predetermined surface area thereof. The plurality of electrode terminals 133 may be the same length. The plurality of electrode terminals 133 may be different lengths. The plurality of electrode terminals 133 may be configured in such a manner that the electrode terminal 133 that is first stacked has a length shorter than an electrode terminal 133 that is subsequently stacked on the first electrode terminal 133, which may enhance and/or improve contact efficiency between the plurality of electrode terminals 133.

The electrode terminal 133 may protrude through an electrode terminal passage hole 142 (including 142a, 142b for example) formed in the circuit board 140. The plurality of electrode terminals 133 may be stacked or overlapped on the bus bars 150 disposed on the circuit board 140.

The electrode terminals 133 may be stacked in such a manner that one bent electrode terminal 133 is disposed on the bus bar 150 and another bent electrode terminal 133 is then stacked on the previous bent electrode terminal 133 so as to form an area that overlaps the previous bent electrode terminal 133.

The electrode terminal 133 may be provided with an electrode terminal hole 135 into which a boss 145 (including 145a, 145b for example) is fitted. The electrode terminal hole 135 may be configured to have a size corresponding to the size of the boss 145. The electrode hole 135 may be composed of a plurality of electrode terminal holes, which are arranged vertically.

The boss 145 may be fitted into the electrode terminal hole 135 so as to couple the electrode terminal 133 to the circuit board 140. The boss 145 may be fitted into the electrode terminal hole 135 so as to maintain the electrode terminal 133 in a temporarily coupled state prior to the final coupling.

The electrode terminal 133 may be stacked on the circuit board 140 while the boss 145 is fitted into the electrode terminal hole 135. The electrode terminal 133 may be stacked on the bus bar 150 while the boss 145 is fitted into the electrode terminal hole 135.

The electrode terminals 133 may be stacked in such a manner that one bent electrode terminal 133a is disposed on the bus bar 150 and another bent electrode terminal 133b is then stacked on the previous bent electrode terminal 133a so as to form an area that overlaps the previous bent electrode terminal 133a.

Referring to FIG. 4, the circuit board 140 may include a plate-shaped circuit board body 141 having a rectangular plate shape overall. The circuit board 140 may include the boss 145 protruding from one side thereof. The boss 145 may be configured to have a cylindrical shape, and may be easily fitted into and coupled to the electrode terminal hole 135 formed in the electrode terminal 133.

The circuit board 140 may include the boss 145 perpendicularly protruding from the surface thereof that faces the cover clip 160. The boss 145 may be fitted into the bus bar 150, the electrode terminal 133 and the cover clip 160, and may be coupled thereto.

The height of the boss 145 may be determined in consideration of the thicknesses of the bus bar 150, the plurality of bent electrode terminals 133a and 133b and the cover clip 160 into which the boss 145 is fitted. The height of the boss 145 may be set to be larger than the total height of the bus bar 150, the plurality of bent electrode terminals 133 and the cover clip 160, which are stacked on the circuit board 140, so as to fully pass through the bus bar 150, the plurality of bent electrode terminals 133a and 133b and the cover clip, which are stacked.

The boss 145 may couple the bus bar 150, the plurality of bent electrode terminals 133 and the cover clip 160 to the circuit board 140, thereby preventing separation thereof after the coupling. The circuit board 140 may include a plurality of bosses 145 in order to increase the coupling force between the circuit board 140 and the bus bar 150, the electrode terminals 133 and the cover clip 160.

The plurality of bosses 145 may be arranged vertically, and may be coupled to the bus bar 150, the electrode terminals 133 and the cover clip 160 in order to increase the coupling force between the circuit board 140 and the bus bar 150, the electrode terminals 133 and the cover clip 160. The plurality of bosses 145 may be arranged in an anteroposterior direction at predetermined intervals so as to be coupled to plurality of components.

The boss 145 may be fitted into the electrode terminal hole 135 formed in the electrode terminal 133 so as to couple the electrode terminal 133 to the circuit board 140. The boss 145 may be fitted into the electrode terminal hole 135 so as to prevent separation of the electrode terminal 133 from the circuit board 140. The electrode terminal 133 may be stacked on the circuit board 140 while the boss 145 is fitted into the electrode terminal hole 135. The electrode terminal 133 may be stacked on the bus bar 150 disposed on the circuit board 140 while the boss 145 is fitted into the electrode terminal hole 135.

The boss 145 may be fitted into the bus bar hole 155 formed in the bus bar 150 so as to couple the bus bar 150 to the circuit board 140. The boss 145 may be fitted into the bus bar hole 155 so as to prevent separation of the bus bar 150 from the circuit board 140. The bus bar 150 may be stacked on the circuit board 140 in the state in which the boss 145 is fitted into the bus bar hole 155.

The boss 145 may be fitted into a coupling hole 165 (including 165a, 165b for example) formed in the cover clip 160 so as to couple the cover clip 160 to the circuit board 140. The boss 145 may be fitted into the coupling hole 165 so as to prevent separation of the cover clip 160 from the circuit board 140. The cover clip 160 may be stacked on the circuit board 140 while the boss 145 is fitted into the coupling hole 165. The cover clip 160 may be stacked on the bus bar 150 disposed on the circuit board 140 while the boss 145 is fitted into the coupling hole 165. The cover clip 160 may be stacked on the electrode terminal 133 disposed on the circuit board 140 while the boss 145 is fitted in through the coupling hole 165.

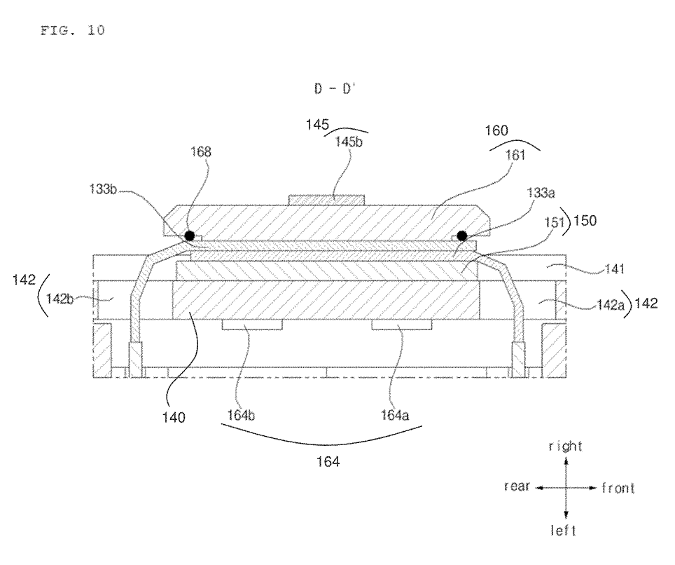

Referring to FIGS. 4 and 10, the circuit board 140 may include the electrode terminal passage hole 142 through which the electrode terminal 133 passes. The electrode terminal passage hole 142 may be formed to be vertically elongate. The electrode terminal passage hole 142 may be composed of a plurality of electrode terminal passage holes 142 corresponding in number to the number of plurality of electrode terminals 133. The plurality of electrode terminal passage holes 142 may be arranged on the circuit board 140 in the anteroposterior direction.

The electrode terminal passage hole 142 may serve to dispose the electrode terminal 133 inserted there into to be spaced apart from the circuit board 140 such that the electrode terminal 133 easily passes through the circuit board 140 upon assembly.

The electrode terminal passage hole 142 may provide a space between the electrode terminal 133 and the circuit board 140 so as to prevent the electrode terminal 133 from being electrically connected to the circuit board 140, thereby preventing unwanted energy loss.

Referring to FIG. 10, because it is difficult to accurately bend the electrode terminal 133 at an angle of 90 degrees owing to particular characteristics of the manufacturing process, size of the electrode terminal passage hole 142 may be determined such that the electrode terminal 133 is spaced apart from the circuit board 140 in consideration of bendability of the bent portion of the electrode terminal 133.

The electrode terminals 133 may be arranged in the anteroposterior direction. The bent electrode terminals 133 may pass through the circuit board 140 and may be stacked one on each other between the circuit board 140 and the cover clip 160.

The electrode terminal 133 may protrude through the electrode terminal passage hole 142 formed in the circuit board 140. The bent electrode terminals 133 may be stacked on the bus bar 150 disposed on the circuit board 140. The electrode terminals 133 may be stacked in such a manner that one bent electrode terminal 133 is disposed on the bus bar 150 and another bent electrode terminal 133 is then stacked on the previous bent electrode terminal 133 so as to form an area that overlaps the previous bent electrode terminal 133.

One of the circuit board 140 and the cover clip 160 may include a coupling protrusion, and the other thereof may include a structure corresponding to the coupling protrusion. The coupling protrusion may be composed of snap protrusions 163 (including 163a, 163b for example) and snap protrusions 164 (including 164a, 164b for example). The structure corresponding to the coupling protrusion may be composed of snap holes or receptacles 143 (including 143a, 143b for example) and snap holes or receptacles 144 (including 144a, 144b for example), which are engaged with the snap protrusions 163 and 164 in a snap-fit manner.

In the embodiment, the circuit board 140 includes the snap protrusions 163 and 164, whereas the cover clip 160 includes the snap holes 143 and 144. Alternatively, it may be also possible to provide a configuration in which the cover clip 160 includes the snap protrusions 163 and 164 whereas the circuit board 140 includes the snap holes 143 and 144.

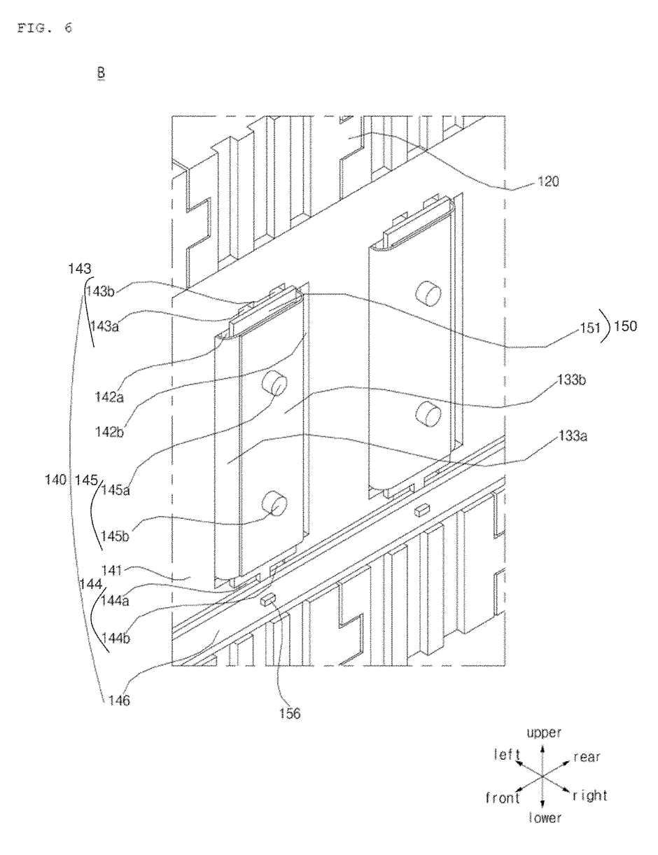

Referring to FIG. 6, the snap holes 143 and 144 may be formed in a peripheral region of the bus bar 150 and the circuit board 140. The snap holes 143 and 144 may be disposed to be coupled to the snap protrusions 163 and 164. The snap holes 143 and 144 may include a plurality of snap holes 143 and 144 corresponding in number to the number of snap protrusions 163 and 164.

The snap holes 143 and 144 may include an upper snap hole 143 disposed at an upper side of the bus bar 150. The snap holes 143 and 144 may include a lower snap hole 144 disposed at a lower side of the bus bar 150.

The snap holes 143 and 144 may be positioned such that the distance between the electrode terminal passage hole 142 and the peripheral edge of the circuit board 140 is greater than the distance between the snap holes 143 and 144 and the peripheral edge of the circuit board 140, whereby the cover clip 160 covers the contact area between the plurality of electrode terminals 133 and establishes a snap-fit coupling.

In another embodiment of the present disclosure, the coupling protrusion may be composed of snap protrusions 163 and 164. The structure corresponding to the coupling protrusion may be a snap groove, which is engaged with the snap protrusions 163 and 164 in a snap-fit manner. The snap groove may be formed in the peripheral region of one of the circuit board 140 and the cover clip 160.

The snap groove may be positioned at the peripheral region of the circuit board 140 so as to be coupled to the snap protrusions of the cover clip 160. The snap groove may guide the snap protrusions 163 and 164 to the coupling position of the circuit board 140.

The snap groove may be formed at an upper side and/or a lower side of the circuit board 140 so as to be coupled to the snap protrusions 163 and 164. Coupling between the snap groove and the snap protrusions 163 and 164 may provide an effect of facilitating attachment and detachment thereof, compared to coupling between the snap holes 143 and 144 and the snap protrusions 163 and 164.

In the embodiment, the snap groove is formed in the circuit board 140 and the snap protrusions 163 and 164 are formed on the cover clip 160. However, it is also possible to provide a configuration in which the snap protrusions 163 and 164 are formed on the circuit board 140 and the snap groove or snap holes are formed in the cover clip 160 so as to allow coupling there between.

In addition, it is also possible to provide a configuration in which the snap groove is formed in an upper portion of the circuit board 140 and the snap holes 143 and 144 are formed in a lower portion of the circuit board 140 such that they are coupled to the snap protrusions 163 and 164 of the cover clip 160. Alternatively, it is also possible to provide a configuration in which the snap holes 143 and 144 are formed in an upper portion of the circuit board 140 and the snap groove is formed in a lower portion of the circuit board 140 such that they are coupled to the snap protrusions 163 and 164 of the cover clip 160.

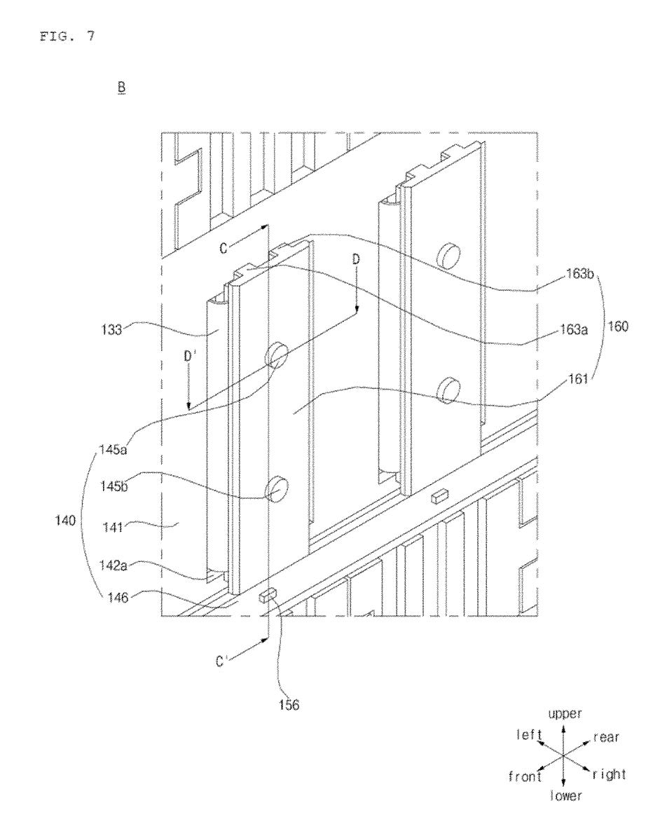

Referring to FIG. 7, the circuit board 140 may include a sub circuit board 146, which serves to electrically connect a plurality of bus bar terminals 156 to each other so as to measure the voltage of each of the battery cells 130. The sub circuit board 146 may be configured to have a rectangular plate shape overall.

The sub circuit board 146 may be disposed on the circuit board 140 so as to contact the bus bar terminals 156. The sub circuit board 146 may extend in an anteroposterior direction so as to contact the plurality of bus bar terminals 156.

A protrusion of the bus bar terminal 156 may be fitted into the sub circuit board 146 and coupled thereto. The sub circuit board 146 may be electrically connected to the bus bar terminal 156 so as to measure the voltage of each of the battery cells 130. The sub circuit board 146 may transmit information about the measured voltage of the battery cell to a controller (not shown).

The circuit board 140 may include voltage terminals 147 through which voltage is input and output. The voltage terminals 147 may be provided at front and rear portions of an upper side of the circuit board 140. The voltage terminals 147 may allow voltage to be output to the outside of the battery module 100. Furthermore, the voltage terminals 147 may allow external voltage or charge external of the battery module 100 to be input to the battery module 100.

Referring to FIG. 4, the bus bar 150 may include a bus bar body 151 having a rectangular plate shape overall. The bus bar body 151 may be configured to extend vertically.

The bus bar 150 may be disposed between a pair of electrode terminal passage holes 142, which are arranged in the circuit board 140 in the anteroposterior direction. The bus bar 150 may be disposed between a pair of snap protrusions 163 and 164, which are arranged vertically along the circuit board 140.

The bus bar 150 may be coupled at one surface thereof to the circuit board 140 while being in contact with the circuit board 140. The bus bar 150 may be coupled to the circuit board 140 by using, for example, heat fusion or other application of heat, such as at point 158, for example.

The bus bar 150 may be disposed between the circuit board 140 and the cover clip 160 so as to contact the electrode terminal 133. The bus bar 150 may contact the electrode terminal 133 so as to be electrically connected thereto.

Because it is difficult to accurately bend the electrode terminal 133 at an angle of 90 degrees owing to the particular characteristics of the manufacturing process, the bus bar 150 may be configured which may improve the state of contact between the bus bar 150 and the electrode terminal 133 in consideration of bendability of the bent portion of the electrode terminal 133. The bus bar 150 may be rounded at the edge region thereof that is positioned to correspond to the bent portion of the electrode terminal 133, which may improve the state of contact between the bus bar 150 and the bent electrode terminal 133.

The plurality of bus bars 150 may be arranged in series in the direction in which the plurality of battery cells 130 are stacked on each other so as to be electrically connected to respective one of the battery cells 130. The bus bar 150 may be coupled to the circuit board 140 in a contacting state. Each of the bus bars 150 may include the bus bar terminal 156, which protrudes in one direction, and may contact the sub circuit board 146 so as to be electrically connected thereto.

The bus bar 150 may be provided with the bus bar hole 155 into which the boss 145 is fitted. The bus bar 150 may be provided in the center thereof with the bus bar hole 155 such that the boss 145 is fitted into and through the bus bar hole 155 and is coupled thereto. The bus bar 150 may include bus bar holes 155 in a number corresponding to the number of plurality of bosses 145, which may increase the coupling force between the bus bar 150 and the circuit board 140.

The boss 145 may be fitted into the bus bar hole 155 so as to couple the bus bar 150 to the circuit board 140. The boss 145 may be fitted into the bus bar hole 155 so as to maintain the bus bar 150 and the circuit board 140 in a temporarily coupled state prior to the final coupling.

The electrode terminal may be stacked on the bus bar 150 while the boss 145 is fitted into the electrode terminal hole 135. The bus bar 150 may be stacked on the circuit board 140 while the boss 145 is fitted into the bus bar hole 155.

The bus bar 150 may include the bus bar terminal 156, which protrudes in one direction so as to contact the sub circuit board 146.

The bus bar terminal 156 comes into contact with the sub circuit board 146 such that the bus bar 150 is electrically connected to the sub circuit board 146. The bus bar terminal 156 may be provided at the end thereof with a protrusion that is fitted into and coupled into the hole formed in the sub circuit board 146 such that the bus bar 150 is steadily and electrically connected to the sub circuit board 146.

Referring to FIGS. 5, 7 and 8, the cover clip 160 may include a cover clip body 161, which is configured to have a rectangular shape overall. The cover clip 160 may be made of an elastic material that is elastic in order to be detachably coupled to the circuit board 140 in a snap-fit manner.

One of the circuit board 140 and the cover clip 160 may include the coupling protrusion, and the other thereof may include a structure corresponding to the coupling protrusion. The coupling protrusion may be composed of the snap protrusions 163 and 164. The structure corresponding to the coupling protrusion may be composed of the snap holes 143 and 144 that are engaged with the snap protrusions 163 and 164 in a snap-fit manner.

The cover clip 160 is configured to cover the contact area between the electrode 133 and the bus bar 150, when viewed in one direction, so as to protect the electrode terminal 133 and the bus bar 150 from external shocks. The cover clip 160 may prevent foreign substances from entering the electrode terminal 133 and the bus bar 150. The cover clip 160 may include the snap protrusions 163 and 164, which are coupled to the snap holes 143 and 144 in a snap-fit manner.

In the embodiment, the cover clip 160 includes the snap protrusions 163 and 164, and the circuit board 140 includes the snap holes 143 and 144. Alternatively, it may be possible to provide a configuration in which the circuit board 140 includes the snap protrusions 163 and 164 and the cover clip 160 includes the snap holes 143 and 144.

The snap protrusions 163 and 164 may be disposed so as to be coupled into the snap holes 143 and 144. The snap protrusions 163 and 164 may protrude toward the circuit board 140, and may include hooks formed at the end thereof so as to be coupled into the snap holes 143 and 144.

The snap protrusions 163 and 164 may be detachably coupled into the snap holes 143 and 144 in a snap-fit manner such that each of the battery cells 130 is detachable from the battery module 100.

A number of snap protrusions 163 and 164 corresponding to the number of snap holes 143 and 144 may be provided in order to increase the coupling force between the circuit board 140 and the cover clip 160.

The snap protrusions 163 and 164 may include an upper snap protrusion 163 that is positioned at the upper end of the cover clip 160. The snap protrusions 163 and 164 may include a lower snap protrusion 164 that is positioned at the lower end of the cover clip 160.

Each of the snap protrusions 163 and 164 may be rounded at the portion thereof at which the snap protrusion meets the cover clip 160, so as to prevent breakage of the bent portion attributable to concentration of stress.

The length of the snap protrusions 163 and 164 may be determined based on the total thickness of the elements stacked between the circuit board 140 and the cover clip 160. The length of the snap protrusions 163 and 164 may be determined based on the thickness of the circuit board 140 into which the snap protrusions 163 and 164 are fitted.

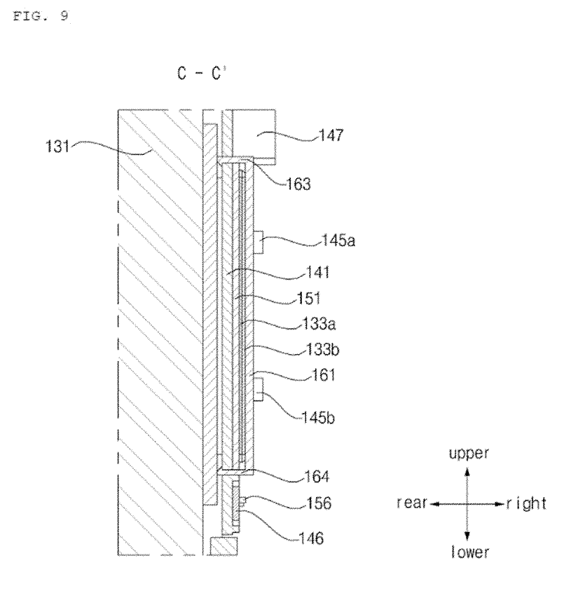

Referring to FIG. 9, the snap protrusions 163 and 164 may have a length greater than the total thickness of the bus bar 150 and the plurality of bent electrode terminals 133, which are stacked between the circuit board 140 and the cover clip 160, plus the depth of the snap holes 143 and 144. The cover clip 160 may be coupled to the circuit board 140 in a snap-fit manner so as to couple the bus bar 150 and the plurality of bent electrode terminals 133 to the circuit board 140. The cover clip 160, which is constructed as described above, may enable the circuit board 140, the bus bar 150 and the plurality of bent electrode terminals 133 to be replaced with other ones.

Each of the snap protrusions 163 and 164 may be provided at the end thereof with the hook, with a surface of the hook that is in contact with the circuit board 140 being inclined toward the snap hole. Insertion of the cover clip 160 into the circuit board 140 may be guided by the inclined surface of the hook, and it may be possible to increase the force with which the plurality of electrode terminals 133 is coupled to the circuit board 140 by the cover clip 160.

In another embodiment of the present disclosure, the structure corresponding to the coupling protrusion may be a snap groove, which is engaged with the snap protrusions 163 and 164 in a snap-fit manner. The snap groove may be formed in a peripheral region of one of the circuit board 140 and the cover clip 160.

The snap protrusions 163 and 164 may be configured so as to be coupled to the snap groove formed in a peripheral region of the circuit board 140. The snap groove may guide the coupling of the snap protrusions 163 and 164 to the circuit board 140.

The snap protrusions 163 and 164 may be coupled to the snap groove formed in an upper side and a lower side of the circuit board 140. The snap protrusions 163 and 164 may be more easily coupled to and removed from the corresponding structure in the combination of the snap protrusions 163 and 164 and the snap groove than in the combination of the snap protrusions 163 and 164 and the snap holes 143 and 144.

In the embodiment, the cover clip 160 includes the snap protrusions 163 and 164, and the circuit board 140 includes the snap groove. Alternatively, it may be possible to provide a configuration in which the circuit board 130 includes the snap protrusions 163 and 164 and the cover clip 160 includes the snap groove.

The cover clip 160 may include the coupling hole 165, into which the boss 145 is fitted. The coupling hole 165 may be formed in the center of the cover clip 160 so as to be engaged with the boss 145.

The coupling holes 165 may include a number of coupling holes 165 in number corresponding to the number of plurality of bosses 145 in order to increase the coupling force between the circuit board 140 and the cover clip 160.

The coupling hole 165 may be configured to have a shape corresponding to the shape of the boss 145 such that the boss 145 is fitted into the coupling hole 165. The coupling hole 165 may be formed to have a circular cross-section so as to correspond to the circular cross-section of the boss 145.

The circuit board 140 and the cover clip 160 may be configured such that the coupling protrusion and the portion corresponding to the coupling protrusion are coupled to each other by heat fusion in order to stably couple the cover clip 160 to the circuit board 140. The circuit board 140 and the cover clip 160, which are coupled to each other by heat fusion, may be separated from each other by the application of heat.

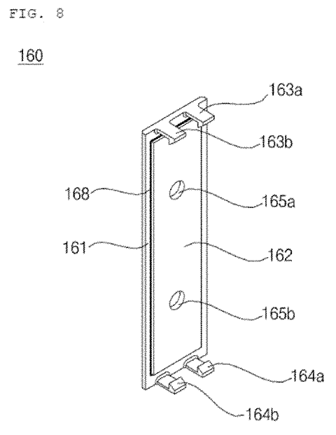

Referring to FIG. 8, when the cover clip 160 comes into contact with the electrode terminal 133, a loose connection may occur due to the rounded portions formed at the connecting regions between the snap protrusions 163 and 164 and the cover clip body 161. The cover clip 160 may include a cover clip contact surface 162 that protrudes from the center of the surface of the cover clip 160 facing the circuit board 140 in order to bring the cover clip 160 into stable contact with the electrode terminal.

The cover clip 160 may include a buffer portion or cushion 168 on the surface facing the circuit board 140 in order to improve the electrical connection of the plurality of electrode terminals disposed between the cover clip 160 and the circuit board 140.

The buffer portion 168 may be made of a material having a certain amount of elasticity. The buffer portion 168 may be a rubber packing.

The buffer portion 168 may be disposed between the peripheral region of the cover clip contact surface 162 and the peripheral region of the cover clip body 161. The buffer portion 168 may be configured so as to protrude further than the cover clip contact surface 162 when the cover clip 160 is separated from the circuit board 140.

The battery module 100, which is constructed as described above, is constructed such that the plurality of electrode terminals 133 of the battery cells 130 are detachably coupled to each other. Accordingly, when one of the plurality of battery cells 130 in the battery module 100 develops a problem, the arrangement of the disclosure provides for being able to separate only the problematic battery cell for replacement.

The battery module 100 provides a mechanical coupling structure designed to electrically connect the plurality of electrode terminals 133 to each other by using, for example, snap-fit coupling between the circuit board 140 and the cover clip 160. Although a conventional coupling structure may provide a problem in which a weld becomes deteriorated due to wear of a welding tool over time, the mechanical coupling structure of the disclosure provides an effect of being able to stably maintain coupling quality for a long period of time.

The battery module according to the embodiment provides an effect of being able to uniformly couple the plurality of electrode terminals 133 to each other, contrary to a conventional coupling structure, in which a welding connection state varies depending on the duration of use, welding point, conditions and the like.

In the conventional art, there is a risk of the interior of a battery cell being damaged by heat generated during welding of a battery module, and the battery module is adversely affected by the heat. The battery module 100 according to the embodiment, which is a mechanical coupling structure employing the cover clip 160, provides an effect of obviating concern about damage to the battery module 100 attributable to heat.

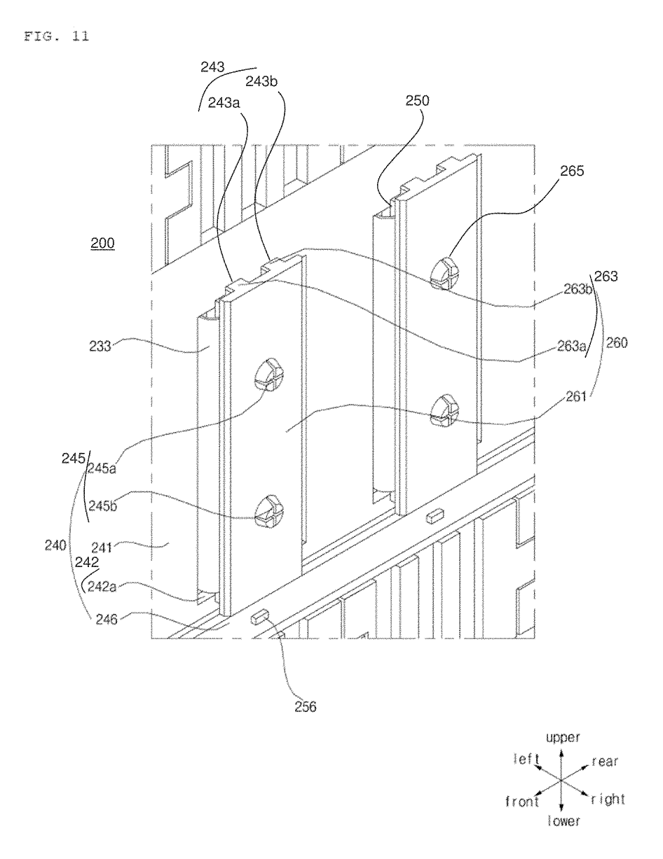

A battery module 200 according to another embodiment of the present disclosure will be described with reference to FIG. 11 with a focus on structures different from those of the first embodiment, and a description of structures identical to those of the first embodiment may be omitted.

A circuit board 240 according to the embodiment may include a boss 245 (including 245a, 245b for example), which is formed on the surface thereof facing the cover clip 260 so as to protrude perpendicular relative to the surface of the circuit board 240.

The boss 245 may be provided at the end thereof with a snap portion for coupling into a coupling hole 265, in the cover clip 260, in a snap-fit manner. The snap portion may be formed by dividing the end of the boss 245. Specifically, the snap portion may be formed by dividing the end of the boss 245 in a crisscross shape.

The snap portion may be coupled to a cover clip 260 in a snap-fit manner after being fitted into the cover clip 260. Since the snap portion provides additional coupling force between the circuit board and the cover clip 260 in addition to the coupling force from the snap-fit coupling between snap protrusions 263 (including 263a, 263b for example) and snap holes 243 (including 243a, 243b for example) and lower snap protrusions and snap holes, it may be possible to increase the coupling force between the circuit board 240 and the cover clip 260.

The snap portion may be fitted into the coupling hole 265 in the cover clip 260, and then coupled to the cover clip 260 by using, for example, heat fusion. It may be possible to stably couple the cover clip 260 to the circuit board 240. The circuit board 240 and the cover clip 260, which are coupled to each other by using, for example, heat fusion, may be separated from each other by the application of heat.

A coupling hole in an electrode terminal 233 may be sized such that the boss 245 including the snap portion is fitted into the hole. A coupling hole in a bus bar 250 may be sized such that the boss 245 including the snap portion is fitted into the hole. A coupling hole 265 in the cover clip 260 may be sized such that the boss 245 including the snap portion is fitted into the hole.

FIG. 11 also shows circuit board body 241, electrode terminal passage hole 242a, sub circuit board 246, bus bar terminal 256, and cover clip body 261.

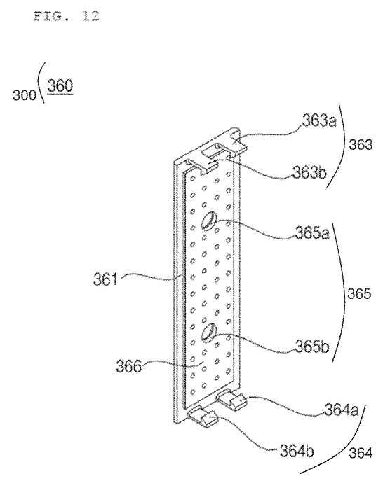

Hereinafter, a battery module 300 according to a further embodiment of the present disclosure will be described with reference to FIG. 12 with a focus on structures different from those of the battery module 100 according to the first embodiment, and a description of structures identical to those of the battery module 100 of the first embodiment may be omitted.

A bus bar 150 according to the embodiment may be provided a surface thereof facing a cover clip 360 with a plurality of protrusions, in order to improve the electrical connectivity of a plurality of bent electrode terminals 133 disposed between the bus bar 150 and the cover clip 360.

The plurality of protrusions, which are formed on the surface of the bus bar 150 facing the cover clip 360, may be arranged in a matrix pattern. The plurality of protrusions may be arranged so as to alternate with a plurality of protrusions formed on the cover clip 360 in order to improve the electrical connectivity of a plurality of bent electrode terminals 133 disposed between the bus bar 150 and the cover clip 360.

The cover clip 360 according to the embodiment may include an electric conductor 366 on the surface thereof that faces a circuit board 140 so as to improve the electric connectivity of the plurality of electrode terminals 133. The cover clip 360 may be provided, in the surface thereof that faces the circuit board 140, with a recess for receiving the electric conductor 366 therein, and the electric conductor 366 may be partially fitted into the recess.

The cover clip 360 may include a coupling hole 365 (including 365a, 365b for example) into which a boss 145 is fitted. The cover clip 360 may have formed therein the coupling hole 365, which allows the boss 145 to be fitted into the cover clip body 361 and the electric conductor 366.

The cover clip 360 may include an uneven portion on the surface thereof that faces the circuit board 140. The cover clip 360 may include the uneven portion composed of a plurality of protrusions, which protrude a predetermined height and are arranged in a matrix pattern.

The cover clip 360 may include the plurality of protrusions provided on the electric conductor 366 so as to improve the electrical connectivity of the plurality of bent electrode terminals 133 disposed between the bus bar 150 and the cover clip 360. The cover clip 360 may include the plurality of protrusions provided on the surface of the electrical conductor 366 that faces the circuit board 140, the plurality of protrusions being arranged in a matrix pattern.

The plurality of protrusions may be alternately arranged with the plurality of protrusions formed on the bus bar 150 so as to improve the electrical connectivity of the plurality of bent electrode terminals 133 disposed between the bus bar 150 and the cover clip 360.

Although the cover clip 360 according to the embodiment includes the plurality of protrusions provided on the electrical conductor 366, the plurality of protrusions may alternatively be provided on the surface of the cover clip body 361 that faces the circuit board 340, without the electrical conductor 366. As shown in FIG. 12, the cover clip 360 may include snap protrusions 363a, 363b, 364a, 364b.

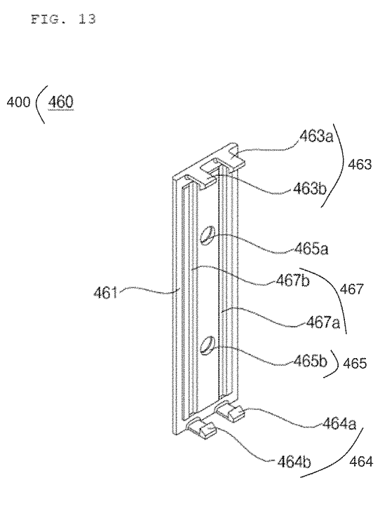

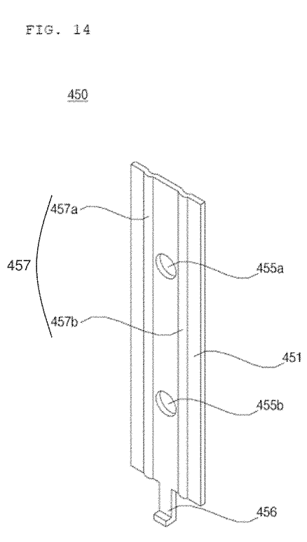

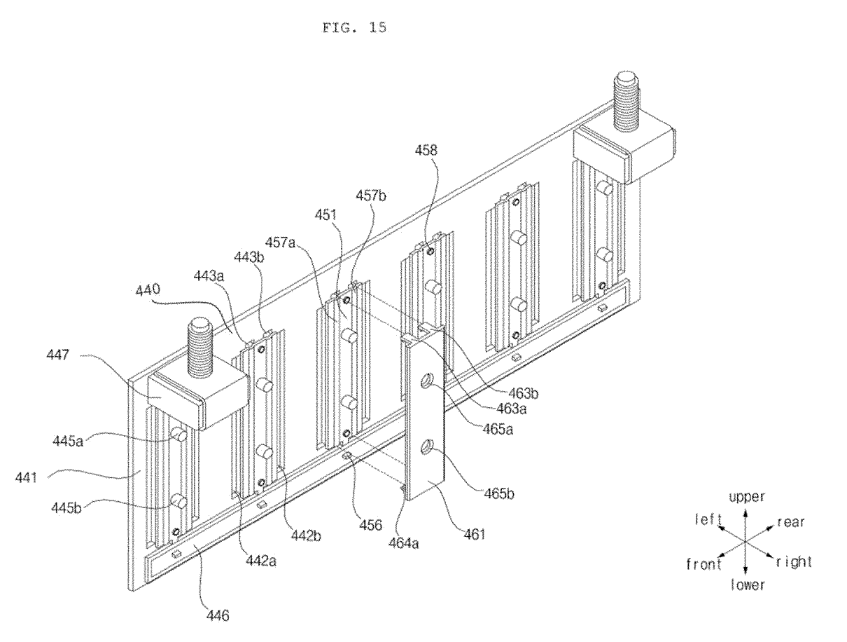

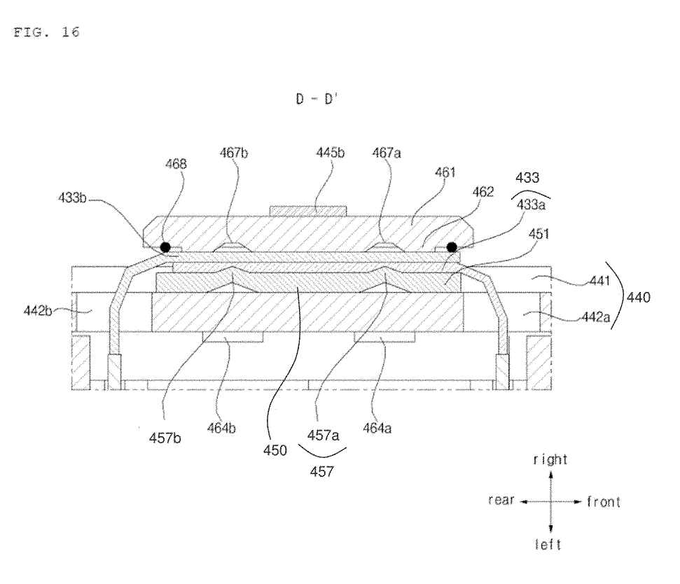

A battery module 400 according to a further embodiment of the present disclosure will be described with reference to FIGS. 13 to 16 with a focus on structures different from those of the battery module 100 according to the first embodiment, and a description of structures identical to those of the battery module 100 of the first embodiment may be omitted.

A bus bar 450 according to the embodiment may include a linear protrusion 457 (including 457a, 457b for example) that corresponds to a linear groove 467 (including 467a, 467b for example) in a cover clip 460 which may improve the electrical connectivity of a plurality of bent electrode terminals 433 (including 433a, 433b for example) disposed between the bus bar 450 and the cover clip 460.

The linear protrusion 457 may be positioned at the center of the bus bar 450 and may extend in the longitudinal direction of the bus bar 450. The linear protrusion 457 may extend vertically.

The linear protrusion 457 may extend to the lower end of the bus bar 450 from the upper end of the bus bar 450. The linear protrusion 457 may be composed of a pair of linear protrusions 457a and 457b, which are disposed parallel to each other.

The linear protrusion 457 may be positioned so as to be vertically aligned with the point at which the cover clip 460 and the circuit board 440 are coupled to each other in a snap-fit manner when the bus bar 450 is disposed on the circuit board 440, thereby allowing the pressure resulting from snap-fit coupling to be efficiently transmitted to the electrode terminals 433 contacting the linear protrusion 457.

The linear protrusion 457 may protrude by a height corresponding to the depth to which the linear groove 467 is formed in the cover clip 460. The linear protrusion 457 may be connected to the surface of the bus bar 450 so as to improve the contact efficiency with the plurality of electrode terminals 433.

Although the linear protrusion 457 is illustrated as being configured to have a triangular cross-section in the embodiment, the linear protrusion 457 may be configured to have some other cross-section shape.

In the embodiment, the cover clip 460 may include an uneven portion provided on the surface thereof that faces the circuit board 440 so as to improve the electrical connectivity of the plurality of electrode terminals 433. The uneven portion may be embodied as the linear groove 467, which extends in the longitudinal direction of the cover clip 460.

The linear groove 467 may be positioned at the center of the cover clip 460 and may extend in the longitudinal direction of the cover clip 460. The linear groove 467 may extend vertically.

The linear groove 467 may extend to the lower end of the cover clip 460 from the upper end of the cover clip 460. The linear groove 467 may be composed of a pair of linear grooves 467a and 467b, which are disposed parallel to each other in a horizontal direction.

The linear grooves 467a and 467b may be aligned with the snap protrusions 463 (including 463a, 464b) and snap protrusions 464 (including 464a, 464b) in a vertical direction so as to efficiently transmit pressure resulting from the snap-fit coupling to the electrode terminals 433 contacting the linear grooves.

The linear groove 467 may be depressed by a depth corresponding to the height of the linear protrusion 467 formed on the bus bar 450. The linear groove 467 may be connected to the surface of the cover clip 460 and may correspond to the linear protrusion 457 which may improve the contact efficiency with the plurality of electrode terminals 433.

Although the linear groove 467 is illustrated as being configured to have a triangular cross-section in the embodiment, the linear groove 467 may be configured to have some other cross-sectional shape.

FIGS. 13-16 further show circuit board body 441; electrode terminal passage holes 442a, 442b; snap holes 443a, 443b; bosses 445a, 445b; sub circuit board 446; voltage terminals 447; bus bar body 451; circuit board/bus bar attachment 458; bus bar holes 455a, 455b; bus bar terminal 456; cover clip body 461; cover clip contact surface 462; coupling holes 465a, 465b (of the cover clip 460); and buffer portion 468.

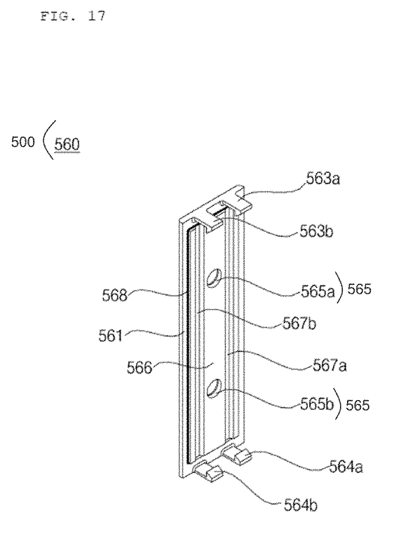

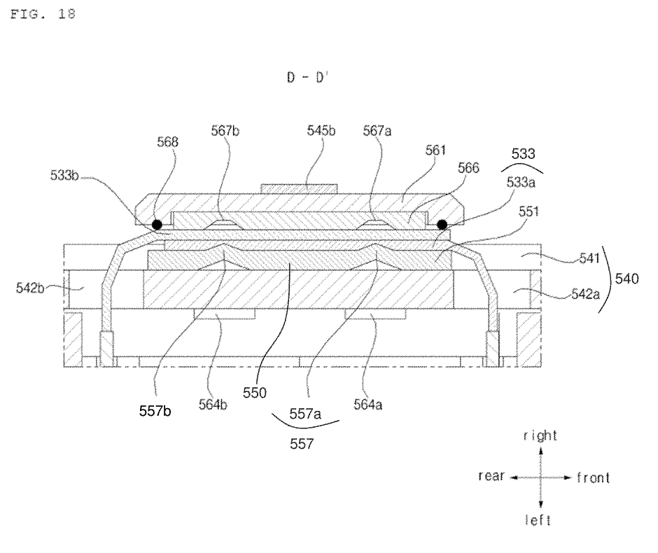

Hereinafter, a battery module 500 according to still a further embodiment of the present disclosure will be described with reference to FIGS. 17 and 18 with a focus on structures different from those of the battery module 100 according to the first embodiment, and a description of structures identical to those of the battery module 100 of the first embodiment may be omitted.

A cover clip 560 according to the embodiment may include an electric conductor 566 provided on the surface thereof that faces a circuit board 540 so as to improve electrical connectivity with a plurality of electrode terminals 533 (including 533a, 533b for example). The cover clip 560 may be provided, in the surface thereof that faces the circuit board 540, with a recess for receiving the electrical conductor 566, and the electrical conductor 566 may be fitted partway into the recess.

The cover clip 560 may include a coupling hole 565 (including 565a, 565b for example) into which a boss 545b is fitted. The coupling hole 565 may be formed so as to allow the boss 545b to be fitted into the cover clip body 561 and the electrical conductor 566.

The cover clip 560 may include an uneven portion on the surface thereof that faces the circuit board 540, so as to improve electrical connectivity with a plurality of electrode terminals 533. The uneven portion may be embodied as a linear groove 567 (including 567a, 567b for example), which extends in the longitudinal direction of the cover clip 560.

The linear groove 567 may extend to the lower end from the upper end of the electrical conductor 566 disposed on the surface of the cover clip 560 that faces the circuit board 540. The linear groove 567 may be composed of a pair of linear grooves 567a, 567b, which are formed in the electrical conductor so as to be parallel to each other in a horizontal direction. The linear groove 567 may be formed in the electrical conductor 566 so as to improve the electrical connectivity of the plurality of electrode terminals 533.

A bus bar 550 according to the embodiment may include a linear protrusion 557 (including 557a, 557b for example) that corresponds to the pair of linear grooves 567 in a cover clip 560 so as to improve the electrical connectivity of a plurality of bent electrode terminals 533 disposed between the bus bar 550 and the cover clip 560.

The cover clip 560 may include a buffer portion or cushion 568 provided on the surface thereof that faces the circuit board 540 so as to improve the electrical connectivity of the plurality of electrode terminals disposed between the cover clip and the circuit board.

The buffer portion 568 may be made of a material having a predetermined elasticity. The buffer portion 568 may be a rubber packing.

The buffer portion 568 may be disposed between the peripheral region of the electrical conductor 566 and the peripheral region of the cover clip body 561. The buffer portion 568 may be configured so as to protrude further than the electrical conductor 566 when the cover clip 560 is separated from the circuit board 540.

FIG. 17-18 further show circuit board body 541; electrode terminal passage holes 542a, 542b; snap protrusions 563a, 563b; and snap protrusions 564a, 564b.

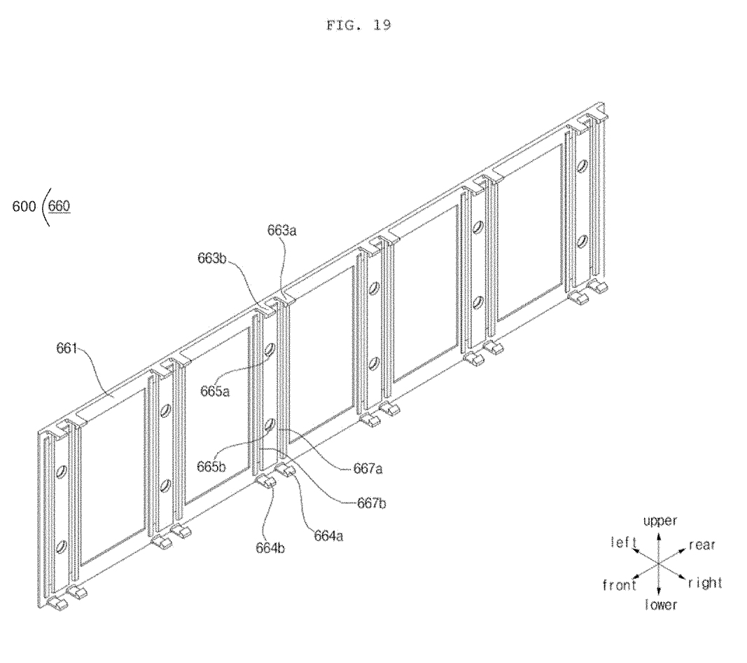

Hereinafter, a battery module 600 according to yet a further embodiment of the present disclosure will be described with reference to FIG. 19 with a focus on structures different from those of the battery module 100 according to the first embodiment, and a description of structures identical to those of the battery module 100 of the first embodiment may be omitted.

A cover clip 660 according to the embodiment may include a plurality of covers, which bring bent electrode terminals 133 into contact with a bus bar 150. The cover clip 660 may cover a plurality of units, each of which is composed of the electrode terminal 133 and the bus bar 150, which are stacked. The cover clip 660 may be configured to have a plurality of cover clips 660 according to the first embodiment, which are connected to each other.

Since the cover clip 660, which is constructed as described above may simultaneously cover a plurality of units, each of which is comprised of the electrode terminal 133 and the bus bar 150 that are stacked, it may be possible to facilitate coupling between the cover clip 660 and the circuit board 140.

In addition, since the cover clip 660 is configured to have a plurality of covers, which are connected to each other, the manufacture thereof may be facilitated. Furthermore, since the plurality of covers of the cover clip 660 are connected to each other and combine their coupling force, it may be possible to increase the coupling force between the cover clip and the circuit board 140.

FIG. 19 further shows coupling holes 665a, 665b; cover clip body 661; snap protrusions 663a, 666b; snap protrusions 664a, 664b; and linear grooves 667a, 667b.

Since the battery module according to the present disclosure includes the cover clip, which is coupled to the circuit board so as to cause the bent electrode terminals to contact the bus bar, and the circuit board and the cover clip are detachably coupled thereto, there may be an advantage of allowing the plurality of battery cells to be detachably coupled thereto.

Since the battery module is configured such that one of the circuit board and the cover clip includes the snap protrusion and the other thereof includes the snap hole, it may be possible to detachably couple the plurality of bent electrode terminals and the bus bar.

When one of the plurality of battery cells constituting the battery module develops a problem, the cover clip is separated from the circuit board, and electrode terminals connected to each other are separated from each other, thereby allowing the problematic battery cell to be removed from the battery module.

The battery module according to the present disclosure, which includes the circuit board and the cover clip, which are coupled thereto, and which electrically connects the plurality of electrode terminals to each other, may provide advantages in that there is no problem in which welding quality is deteriorated due to wear of welding tools over time in a conventional process of manufacturing a battery module and in that it is possible to uniformly couple the electrode terminals to each other.

The battery module according to the present disclosure, in which the circuit board, the electrode terminals, the bus bar and the cover clip are mechanically coupled to each other, confers an advantage in that there is no concern about damage to the battery cell attributable to generation of high-temperature heat, unlike a conventional welding process.

The battery module according to the present disclosure, which includes the linear groove longitudinally formed in the surface of the cover clip that faces the circuit board, and the linear protrusion formed on the bus bar so as to correspond to the linear groove, confers an advantage in that it may be possible to improve electrical connectivity between the electrode terminals of the plurality of battery cells.

The present disclosure provides a battery module in which battery cells are individually coupled to the battery module in a detachable manner. Further, a problem in which welding quality is deteriorated due to wear of welding tools over time in a process of manufacturing a battery module may be solved.

A problem in which a battery cell is damaged due to heat generated during welding of a battery module may be solved based on the present disclosure.

The electrical connectivity of a battery cell may be improved based on the present disclosure.

In accordance with an aspect of the present disclosure, the above and other objects can be accomplished by the provision of a battery module including a plurality of battery cells, which are stacked on each other and each of which includes electrode terminals which protrude at one side of the plurality of battery cells and are bent, at least one bus bar each of which is configured to electrically connect the electrode terminals of adjacent battery cells among the plurality of battery cells to each other, a circuit board disposed at the one side of the plurality of battery cells and including voltage terminals through which voltage is input and output, and at least one cover clip coupled to the circuit board so as to bring the bent electrode terminals into contact with the at least one bus bar.

One of the circuit board and each of the cover clips may include a snap protrusion, and the other of the circuit board and each of the cover clips may include a snap hole, which is coupled to the snap protrusion in a snap-fit manner.

The bent electrode terminals of the plurality of battery cells may pass through the circuit board and be stacked on each other between the circuit board and each of the cover clips. Each of the bus bars may be disposed between the circuit board and a corresponding one of the cover clips. The circuit board may include electrode terminal passage holes through which the electrode terminals pass.

The circuit board may include a snap hole formed between each of the bus bars and a peripheral edge of the circuit board. Each of the cover clips may cover a contact portion between a corresponding one of the electrode terminals and a corresponding one of the bus bars when viewed in one direction and may include a snap protrusion coupled to the snap hole in a snap-fit manner.

Each of the cover clips may include a linear groove formed in a surface that faces the circuit board, the linear groove extending in a longitudinal direction of the cover clip.

Each of the bus bars may include a linear protrusion that is formed to correspond to the linear groove.

A battery module comprising a first cell having a first electrode terminal, a second cell having a second electrode terminal, and the first electrode terminal and the second electrode terminal forming an electrode terminal set; at least one bus bar having a bus bar contact surface, a support provided on one side of the first and second cells, and at least one cover clip that engages into the support to sandwich the electrode terminal set and the bus bar contact surface to prevent separation of contact between at least one of (a) the first and second electrode terminals or (b) the bus bar contact surface and the electrode terminal set.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of at least one of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A battery module comprising:
a first cell having a first electrode terminal;
a second cell having a second electrode terminal, and the first electrode terminal and the second electrode terminal forming an electrode terminal set;
at least one bus bar having a bus bar contact surface;
a support provided on one side of the first and second cells; and
at least one cover clip that engages into the support to sandwich the electrode terminal set and the bus bar contact surface to prevent separation of contact between at least one of (a) the first and second electrode terminals or (b) the bus bar contact surface and the electrode terminal set.

2. The battery module according to claim 1,
wherein a coupling protrusion is provided on the support, and a receptacle, corresponding to the coupling protrusion, is provided on the at least one cover clip, or
wherein the coupling protrusion is provided on the at least one cover clip, and the receptacle, corresponding to the coupling protrusion, is provided on the support.

3. The battery module according to claim 2, wherein the coupling protrusion is a snap protrusion, and
wherein the receptacle is a snap hole, the snap protrusion and the snap hole being snap-fitted to each other.

4. The battery module according to claim 3, wherein the first electrode terminal and the second electrode terminal pass through a first terminal passage hole and a second terminal passage hole of the support, respectively, and overlap over each other between the support and the at least one cover clip, and
wherein the at least one bus bar is provided between the support and the at least one cover clip.

5. The battery module according to claim 4, wherein
the support includes the snap hole formed between the at least one bus bar and a peripheral edge of the support, and
the at least one cover clip covers the bus bar contact surface of the at least one bus bar, and includes the snap protrusion which is engaged with the snap hole.

6. The battery module according to claim 2, wherein the coupling protrusion is a snap protrusion, and
wherein the receptacle is a snap groove, formed in a peripheral region of one of the support and the at least one cover clip, and the snap groove is engaged with the snap protrusion in a snap-fit manner.

7. The battery module according to claim 2,
wherein the support further includes a boss, on a surface of the support that faces the at least one cover clip, which protrudes perpendicularly to the surface of the support, and
the at least one cover clip further includes a coupling hole through which the boss passes.

8. The battery module according to claim 7, wherein the first and the second electrode terminals include electrode terminal holes through which the boss passes, and the at least one bus bar includes a bus bar hole through which the boss passes.

9. The battery module according to claim 7, wherein the support includes a snap portion formed at an end of the boss, which is coupled to the coupling hole in the cover clip in a snap-fit manner.

10. The battery module according to claim 2, wherein the coupling protrusion and the receptacle are attached to each other by application of heat.

11. The battery module according to claim 1, wherein the at least one bus bar is a plurality of bus bars in contact with the support, each bus bar includes a bus bar terminal, and
wherein the support is a circuit board including voltage terminals, through which voltage is input and output, and that further comprises a sub circuit board that is electrically connected to the bus bar terminals so as to measure voltage of the first cell and the second cell.

12. The battery module according to claim 1, wherein the at least one cover clip is further configured to include an uneven portion formed on a surface thereof that faces the support.

13. The battery module according to claim 12, wherein the uneven portion of the at least one cover clip includes a plurality of protrusions, which protrude by a predetermined height and which are arranged in a matrix pattern.

14. The battery module according to claim 12, wherein the uneven portion of each of the at least one cover clip includes a linear groove.

15. The battery module according to claim 14, wherein the at least one bus bar is further configured to include a linear protrusion that is formed to correspond to the linear groove.

16. The battery module according to claim 1, wherein the at least one cover clip is further configured to include an electrical conductor provided on a surface thereof that faces the support.

17. The battery module according to claim 1, wherein the at least one cover clip is further configured to include a cushion provided on a surface thereof that faces the support.

18. The battery module according to claim 1, wherein the at least one cover clip is a single cover clip, and the single cover clip includes a first cover and a second cover;
the first cover provided to sandwich the electrode terminal set with the bus bar contact surface, and the first cell being adjacent to the second cell;
the battery module further including:
a third cell having a third electrode terminal,
a fourth cell having a fourth electrode terminal, and the third electrode terminal and the fourth electrode terminal forming a second electrode terminal set, and
the at least one bus bar including a second bus bar that includes a second bus bar contact surface; and
the second cover provided to sandwich the second electrode set with the second bus bar contact surface, and the third cell being adjacent to the fourth cell.

19. A vehicle comprising the battery module according to claim 1.

20. A battery module comprising:
a cell having an electrode terminal;
a bus bar having a bus bar contact surface;
a support provided on one side of the cell; and
at least one cover clip that engages into the support to sandwich the electrode terminal and the bus bar contact surface to prevent separation of the bus bar contact surface and the electrode terminal.
